(19) United States
(12) Patent Application Publication
(10) Pub. No.: US 2003/0095284 A1
(43) Pub. Date: May 22, 2003

(54) Method and apparatus job retention

(76) Inventor: Travis J. Parry, Boise, ID (US)

Correspondence Address: HEWLETT- PACKARD COMPANY, Intellectual Property Administration, P.O. Box 272400, Fort Collins, CO, 80527-2400, US

(21) Appl. No.: 09/991,755

(22) Filed: Nov. 19, 2001

(51) Int. Cl. B41J 1/00; G06F 15/00

(52) U.S. Cl. 358/1.16; 358/1.15

(57) ABSTRACT

A method of job retention for an imaging device is provided. The method includes receiving an archive file containing one or more print jobs, performing one or more operations based on the archive file type received, and translating each print job of the received archive file into a print-ready format. The method further includes performing one or more user defined operations. In addition, an imaging device is provided that includes a processor adapted to receive and recognize archive files from one or more sources and perform operations based on the archive file type. Each archive file comprises one or more print jobs. A storage device is coupled to the processor and adapted to store archive files and print jobs. The processor is coupled to one of an integral translator or an external translator that is adapted to translate each print job of the archive files into a print-ready format.

### TECHNICAL FIELD

The present invention relates generally to the field of electronic devices and, in particular, imaging devices and the manipulation and storage of jobs for processing.

### BACKGROUND

Imaging devices such as printers, copiers, facsimile machines, scanners, plotters, digital projectors, and terminals, require drivers. The drivers are located at the source where requests for job processing are initiated. The drivers translate the job into print-ready format. Sources requesting job processing include computers, workstations, terminals, and the like. A device driver is a program that controls a particular type of device attached to a computer. There are device drivers for imaging devices, displays, CD-ROM readers, diskette drives, and the like. The driver contains the special knowledge of the device or special software interface that programs using the driver do not. In personal computers, a driver is often packaged as a dynamic link library (DLL).

For example, in order to process print jobs applications such as word processing employ print drivers for each application type. When a print request is implemented, the associated file is translated into a print-ready format using a print driver and then transferred to an imaging device for processing or to storage for later processing. Currently print-ready format files can be retained at imaging devices for processing locally. Print-ready format files are stored at the printer one at a time. When a new printer or group of printers is added to a network or system or one or more printers are replaced in an environment each file that was originally stored at the previous printer(s) has to be reprocessed for printing one at a time. The print job has to be reestablished at the source (personal computer, work station, etc.). The job is located, interpreted by the appropriate driver, based on the driver for the particular operating system, and then transferred to the imaging device as a Printer Control Language File, Post Script File, or the like. Each imaging device having one or more stored jobs is set up individually. The time and effort required to set up files for storage at printers and other imaging devices is extensive in particular in an environment having multiple imaging devices. This is particularly true when configuring new imaging devices and replacing old devices. In an environment having several hundred imaging devices with multiple jobs retained locally, the task of reestablishing the jobs at each imaging device is immense.

For the reasons stated above, and for other reasons stated below which will become apparent to those skilled in the art upon reading and understanding the present specification, there is a need in the art for improvements in the manipulation of stored jobs.

### SUMMARY

The above-mentioned problems with the manipulation and storage of jobs of imaging devices and other problems are addressed by embodiments of the present invention and will be understood by reading and studying the following specification.

In one embodiment, an imaging device is provided. The imaging device includes a processor adapted to receive and recognize archive files from one or more sources and perform operations based on the archive file type. Each archive file comprises one or more print jobs. The imaging device further includes a storage device coupled to the processor and adapted to store archive files and print jobs. In addition, the processor is coupled to one of an integral translator or an external translator that is adapted to translate each print job of the archive files into a print-ready format.

In another embodiment, a method of job retention for one or more imaging devices is provided. The method comprises receiving an archive file containing one or more print jobs, performing one or more operations based on the archive file type received, and translating each print job of the received archive file into a print-ready format. The method further comprises performing one or more user defined operations.

In another embodiment, a computer-usable medium having computer-readable instructions stored thereon for execution by a processor to perform a method of job retention for one or more imaging devices is provided. The method includes receiving an archive file containing one or more print jobs, performing one or more operations based on the archive file type received, and translating each print job of the received archive file into a print-ready format. The method further comprises performing one or more user defined operations.

### BRIEF DESCRIPTION OF THE DRAWINGS

FIG. 1 is a block diagram of an embodiment of a system of imaging devices adapted to perform job retention locally according to the teachings of this invention.

FIG. 2 is flow chart of a method of job retention for an imaging device according to one embodiment of this invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention provide job retention and job manipulation protocol for imaging devices. Files are received at the imaging devices as program files and translated to print-ready format at the imaging devices. The job retention and manipulation protocol enables job storage across multiple devices and the processing of multiple jobs at a single device at one time without the need for device drivers at the source. In addition, embodiments of the present invention provide visual file transfer protocol from the source using a visual program such as CuteFTP, WinZip, or the like.

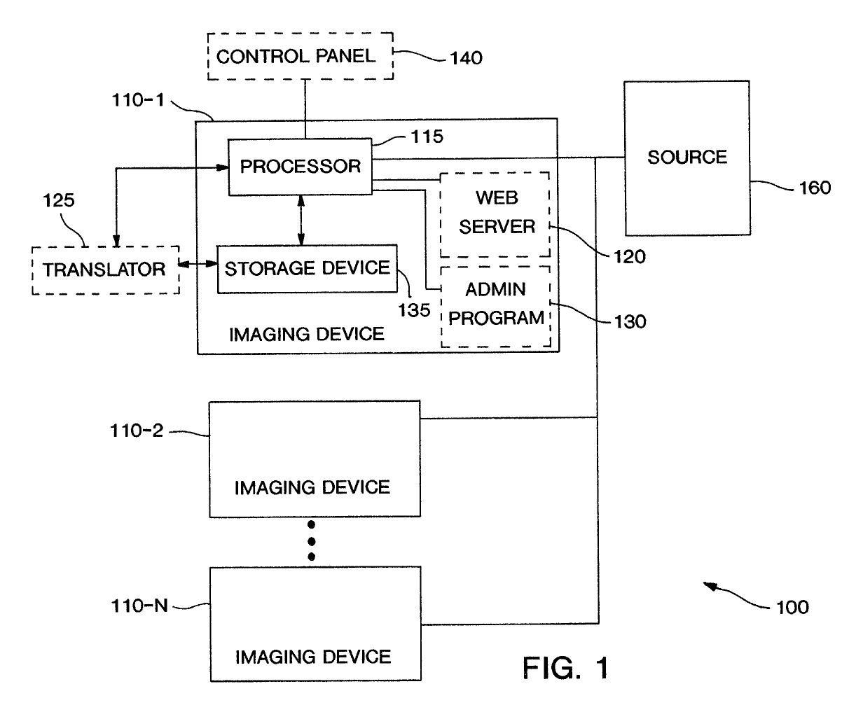

FIG. 1 is a block diagram of an embodiment of a system 100 including multiple imaging devices 110-1 to 110-N. Imaging devices 110-1 to 110-N include printers, copiers, facsimile machines, scanners, plotters, digital projectors, terminals, or the like. Imaging devices 110-1 to 110-N are coupled to a source 160 that presents jobs for processing to imaging devices 110-1 to 110-N. Source 160 includes one or more managing imaging devices, computers, workstations, terminals, processors, or the like. Imaging devices 110-1 to 110-N are substantially similar and as such only imaging device 110-1 will be described in any detail.

Imaging device 110-1 includes a processor 115 adapted to receive jobs for processing from one or more sources 160. Imaging device 110-1 further is coupled to a translator 125 that is separate from imaging device 110-1 or integral to imaging device 110-1. In one embodiment, translator 125 is coupled to processor 115 and translates the received jobs into print-ready format. In addition, imaging device 110-1 includes a storage device 135 for storing either the jobs for processing or the print-ready format files for later retrieval and processing. Storage device 135 comprises a computer-usable media such as a static random access memory (SRAM), dynamic random access memory (DRAM), a non-volatile memory device, a register, magnetic media, optical media, or the like.

In operation, source 160 transfers one or more jobs to one or more of imaging devices 110-1 to 110-N for job retention, processing, further transmission to user-identified addresses and the like. In one embodiment, source 160 transfers files to one or more of imaging devices 110-1 to 110-N using file transfer protocol. In one embodiment, the file transfer protocol is processed through a program such as Visual FTP, CuteFTP, or it is part of an application or operating system such as Explorer, Microsoft, or the like. The file transfer protocol does not require the translation of the application files into print-ready format in order to transfer the files. As a result, device drivers and additional addressing is not required for the transfer.

In one embodiment, the jobs transferred from source 160 are archive files such as compressed files (e.g. zipped), transfer archive (tar) files, and the like. An archive file is a collection of computer files that have been packaged together for backup, to transport to some other location, for saving away form the computer so that more hard disk storage can be made available, or for some other purpose. An archive file can include a simple list of files or files organized under a directory or catalog structure, depending upon how a particular program supports archiving. For example, on personal computers with the Windows operating system, WinZip is a popular program that enables creation of an archive file (a single file that holds a number of files for saving to another medium or transmitting to one or more addresses electronically) or extracts its files. WinZip also compresses the files that are archived, but compression is not required to create an archive file. In UNIX-based operating systems, the tar (tape archive) utility can be used to create an archive file or extract files from one. Web and File Transfer Protocol sites that provide software programs that can be downloaded refer to the list of downloadable files and an archive or as archives.

In one embodiment, the archive files of the jobs transferred from source 160 contain one or more print jobs. Processor 115 receives the files from source 160 and recognizes the type of file received and then performs operations based on the type of file received. In one embodiment, the processor uses the file name, file extension, header information, file format, additional information provided with the file, or the like to recognize the type of file received. The operations include one or more of decompressing each file of the received archive files into separate print jobs, storing one or more of the files of the received archive file as a separate print job in storage device 135, and transmitting one or more files of the received archive files or print jobs of the received archive files to user-identified addresses. For example, when processor 115 recognizes a compressed file, the processor decompresses the files into separate print jobs, determines if one or more of the separate print jobs have associated permissions and/or determines if one or more of the separate print jobs or the archive file require additional processing. The separate print jobs are then transferred to translator 125 for translation into a print-ready format. Additional processing includes transmitting the files, storing the files in a designated directory, notifying an administrator of the receipt of the files or the like. For example, tar files retain the owner/group name and permissions for each file within a tar ball (a group of tar files seemingly stuck together in a ball of tar). Processor 115 assigns natural permissions associated with each file such as personal identification numbers. Translator 125 also translates each file into a print-ready format with any associated permissions attached. In one embodiment, print-ready format includes Printer Control Language, Post Script File, graphical language (i.e. Hewlett Packard graphical language), or the like. User-identified addresses include another device, a directory, a system administrator, an alternate storage location, or the like.

Each translated file is then processed based on one or more user-defined operations. In one embodiment, the user-defined operations include one or more of storing the print jobs for subsequent processing, printing the print jobs, transmitting the print jobs to user-identified addresses, and transferring one or more of the print jobs to an appropriate directory. In one embodiment, transferring one or more of the print jobs to an appropriate directory is based on one or more of a file name associated with the print job, a file type associated with the print job, an address associated with the print job, any permissions such as a personal identification number (PIN) associated with the print job, and an identifier associated with the print job. For print jobs with an associated PIN, a user attempting to retrieve and process the job would be required to provide the PIN before access would be provided.

In another embodiment, imaging device 110-1 further includes an administrative program 130 for device management to include print job management. In one embodiment, print-ready files are provided to administrative program 130 for further manipulation, storage, reporting, or the like. An example of an administrative program is disclosed in U.S. Pat. No. 5,956,487, entitled Embedding Web Access Mechanism in an Appliance for User Interface Functions Including a Web Server and Web Browser. In one embodiment, the print jobs are available for access via a web server 120. In another embodiment, the print jobs are transmitted via web server 120 to one or more user-designated addresses. In one embodiment, the user-designated addresses are web addresses, email address, http addresses, or the like. In another embodiment, print-ready files are posted to one or more user-designated addresses for example, multiple imaging device addresses.

In one embodiment, imaging device 110-1 includes a control panel 140 that is internal or external to imaging device 110-1. In one embodiment, control panel 140 includes a display. In one embodiment, print job information such as status, retrieval, location, and modification of any of this information is accessed via control panel 140. In another embodiment, print job information is accessed via web server 120. In one embodiment, print job information is obtained at a display located at the source 160.

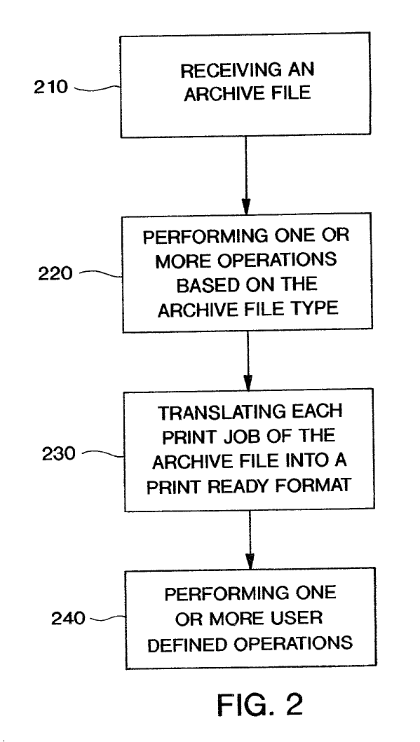

FIG. 2 is a flowchart of a method of file transfer protocol for an imaging device according to one embodiment of this invention. In one embodiment, the imaging device is a printer. The method begins at block 210 and receives an archive file. In one embodiment, the archive file is a compressed set of files such as a zipped file, a tape archive file (tar), or the like.

The method proceeds to block 220 and performs one or more operations based on the archive file type received. For example, in one embodiment, a WinZip, gzip, or other compressed file is received and the file type is recognized and then decompressed into separate print jobs. In one embodiment, a tar ball is received and recognized. Each tar file in a tar ball retains its owner/group name and permissions. A user may provide a personal identification number in order to retrieve and/or process a tar file.

At block 230, the method translates each print job of the received archive file into a print-ready format. The method proceeds to block 240 and the method performs one or more user defined operations. User defined operations include, but are not limited to, printing the job, storing the job for later retrieval, storing the job in an appropriate directory, or the like. In one embodiment, the appropriate directory is based on the file name, file type, address of the file transfer, PIN of the file, or the like. In one embodiment, a print job is stored until a personal identification number is provided and then user defined operations of block 240 are performed.

Storing a job in an appropriate directory in one embodiment is based on the type of file received, the address received with the file, a separate identifier received with the file, or the like.

### Conclusion

Imaging devices adapted to perform job retention using file transfer protocol and methods of job retention for imaging devices have been detailed. In one embodiment, an imaging device has been described. The imaging device includes a processor adapted to receive and recognize archive files from one or more sources and perform operations based on the archive file type. Each archive file comprises one or more print jobs. The imaging device further includes a storage device coupled to the processor and adapted to store archive files and print jobs. In addition, the processor is coupled to one of an integral translator or an external translator that is adapted to translate each print job of the archive files into a print-ready format.

In addition, a method of job retention for one or more imaging devices has been described. The method includes receiving an archive file containing one or more print jobs and performing one or more operations based on the archive file type received. The method further includes translating each print job of the received archive file into a print-ready format and performing one or more user defined operations.

Although specific embodiments have been illustrated and described herein, it will be appreciated by those of ordinary skill in the art that any arrangement, which is calculated to achieve the same purpose, may be substituted for the specific embodiments shown. This application is intended to cover any adaptations or variations of the present invention. Therefore, it is intended that this invention be limited only by the claims and the equivalents thereof.

What is claimed is:

1. An imaging device, comprising:
a processor adapted to receive and recognize archive files from one or more sources and perform operations based on the archive file type, wherein each archive file comprises one or more print jobs;
a storage device coupled to the processor and adapted to store archive files and print jobs; and
wherein the processor is coupled to one of an integral translator or an external translator that is adapted to translate each print job of the archive files into a print-ready format.

2. The imaging device of claim 1, wherein the one or more sources comprise one of a managing printer, a computer, and a processor.

3. The imaging device of claim 1, wherein the print-ready format is one of Printer Control Language, Post Script, and a graphical language.

4. The imaging device of claim 1, wherein the storage device comprises one or more of an SRAM, DRAM, non-volatile memory, register, magnetic media, and optical media.

5. The imaging device of claim 1, wherein the operations which the processor is adapted to perform based on the archive file type include one or more of:
decompressing the print jobs of the archive files;
storing the print jobs of the archive files into appropriate directories; and
transmitting the print jobs of the archive files to user-identified addresses.

6. The imaging device of claim 1, further comprising a control panel coupled to the processor, wherein the control panel is adapted to enable access and manipulation of the archive files and the associated print jobs.

7. The imaging device of claim 1, further comprising an embedded web server coupled to the processor, wherein the embedded web server is adapted to interface between the processor and one or more user-identified addresses.

8. The imaging device of claim 1, wherein the storage device is adapted to store archive files and print jobs based on one or more of the archive file type, archive file name, and an identifier associated with the archive file.

9. The imaging device of claim 1, further comprising an administrative program coupled to the processor and adapted to perform print job management.

10. A method of job retention for one or more imaging devices, comprising:
receiving an archive file containing one or more print jobs;
performing one or more operations based on the archive file type received;
translating each print job of the received archive file into a print-ready format; and
performing one or more user defined operations.

11. The method of claim 10, wherein translating each print job of the received archive file into a print-ready format comprises translating each print job of the received archive file into one of Printer Control Language, Post Script, and a graphical language.

12. The method of claim 10, wherein performing one or more operations based on the archive file type received comprises one or more of:
decompressing each file of the received archive file into separate print jobs;
storing one or more of the files of the received archive file as separate print jobs; and
transmitting one or more files of the received archive file to user-identified addresses as separate print jobs.

13. The method of claim 10, wherein performing one or more user defined operations comprises one or more of:
storing one or more of the print jobs for subsequent processing:
printing one or more of the print jobs;
transmitting one or more of the print jobs to user-identified addresses; and
transferring one or more of the print jobs to an appropriate directory.

14. The method of claim 13, wherein transferring one or more of the print jobs to an appropriate directory comprises transferring one or more of the print jobs to an appropriate directory based on one of a file name associated with the print job, a file type associated with the print job, an address associated with the print job, a personal identification number associated with the print job, and an identifier associated with the print job.

15. The method of claim 10, further comprising transferring the archive file to the one or more imaging devices.

16. A computer-usable medium having computer-readable instructions stored thereon for execution by a processor to perform a method of job retention for an imaging device, the method comprising:
receiving an archive file containing one or more print jobs;
performing one or more operations based on the archive file type received; and
translating each print job of the received archive file into a print-ready format.

17. The method of claim 16, wherein translating each print job of the received archive file into a print-ready format comprises translating each print job of the received archive file into one of Printer Control Language, Post Script, and graphical language.

18. The method of claim 16, wherein performing one or more operations based on the archive file type received comprises one or more of:
decompressing each file of the received archive file into separate print jobs;
storing one or more of the files of the received archive file as separate print jobs; and
transmitting one or more files of the received archive file to user-identified addresses as separate print jobs.

19. The method of claim 16, further comprising performing one or more user defined operations, wherein performing one or more user defined operations comprises one or more of:
storing one or more of the print jobs for subsequent processing:
printing one or more of the print jobs;
transmitting one or more of the print jobs to user-identified addresses; and
transferring one or more of the print jobs to an appropriate directory.

20. The method of claim 19, wherein transferring one or more of the print jobs to an appropriate directory comprises transferring one or more of the print jobs to an appropriate directory based on one of a file name associated with the print job, a file type associated with the print job, an address associated with the print job, a personal identification number associated with the print job, and an identifier associated with the print job.
